(19) United States
(12) Patent Application Publication
(10) Pub. No.: US 2014/0078117 A1
(43) Pub. Date: Mar. 20, 2014

(54) INFORMATION PROCESSING APPARATUS, WRITING INSTRUMENT, INFORMATION PROCESSING METHOD, AND PROGRAM

(71) Applicant: SONY CORPORATION, Tokyo (JP)

(72) Inventor: Yasuharu ASANO, Kanagawa (JP)

(73) Assignee: SONY CORPORATION, Tokyo (JP)

(21) Appl. No.: 14/016,490

(22) Filed: Sep. 3, 2013

(30) Foreign Application Priority Data
Sep. 20, 2012 (JP) 2012206787

(51) Int. Cl. G06F 3/038

(52) U.S. Cl. CPC G06F 3/038
USPC 345/179

(57) ABSTRACT

There is provided an information processing apparatus including a sensor information acquisition unit that acquires sensor information output from a sensor that detects contact of a finger with a surface of a writing instrument, a grip pattern determination unit that determines, based on the sensor information, a grip pattern in which a user grips the writing instrument, and a function execution unit that executes a function relating to the writing instrument according to the grip pattern.

### BACKGROUND

The present disclosure relates to an information processing apparatus, a writing instrument, an information processing method, and a program.

Writing instruments are for writing down characters and figures on a surface of paper to be written upon or the like. In recent years, electronic pens that acquire writing data of users using electronic techniques have also become widespread. Since the acquired writing data is electronically processed in an electronic pen, it is possible to additionally execute various processes not limited to such simple acquisition of writing data when, for example, a user performs an additional operation. For example, Japanese Unexamined Patent Application Publication No. 2011-197744 discloses a technique of adding attribute information that a user desires to writing data by operating a changeover switch provided in an electronic pen or a receiver.

Meanwhile, when a user writes down characters or figures using a writing instrument, the way of gripping the writing instrument is of great interest to the user. In general, there is a correct way of gripping a writing instrument. The correct way of gripping is a proper way of gripping that leads to, for example, reducing a burden on fingers, or writing characters neatly. Learning such a way of gripping is a well-known challenge in using a writing instrument. For example, Japanese Unexamined Patent Application Publication No. 2011-164316 and Japanese Unexamined Patent Application Publication No. 2007-164098 have proposed a writing instrument that helps a user to learn the correct way of gripping by correcting the user's way of gripping a writing instrument.

### SUMMARY

However, in the technology of electronic processing with regard to a writing instrument as disclosed in Japanese Unexamined Patent Application Publication No. 2011-197744 (the data is not necessarily limited to writing data obtained in an electronic manner), for example, a technology focusing on a way of gripping a writing instrument has not yet been proposed.

Thus, it is desirable to propose a novel and improved information processing apparatus, writing instrument, information processing method, and program that enable execution of a proper process according to a user's way of gripping a writing instrument.

According to an embodiment of the present disclosure, there is provided an information processing apparatus including a sensor information acquisition unit that acquires sensor information output from a sensor that detects contact of a finger with a surface of a writing instrument, a grip pattern determination unit that determines, based on the sensor information, a grip pattern in which a user grips the writing instrument, and a function execution unit that executes a function relating to the writing instrument according to the grip pattern.

According to an embodiment of the present disclosure, there is provided a writing instrument including a first sensor that detects contact of a finger with a surface of the writing instrument, and a sensor information providing unit that provides sensor information output from the first sensor to a device that determines, based on the sensor information, a grip pattern in which a user grips the writing instrument.

According to an embodiment of the present disclosure, there is provided an information processing method including acquiring sensor information output from a sensor that detects contact of a finger with a surface of a writing instrument, determining, based on the sensor information, a grip pattern in which a user grips the writing instrument, and executing a function relating to the ng instrument according to the grip pattern.

According to an embodiment of the present disclosure, there is provided a program causing a computer to realize a function of acquiring sensor information output from a sensor that detects contact of a finger with a surface of a writing instrument, a function of determining, based on the sensor information, a grip pattern in which a user grips the writing instrument, and a function of executing a function relating to the writing instrument according to the grip pattern.

According to the embodiments of the present disclosure described above, a user's way of gripping a writing instrument is specified as a grip pattern. The grip pattern is determined based on contact of fingers with a surface of the writing instrument. The grip pattern may be used to identify, for example, a correct way of way of gripping and an incorrect way of gripping, or regardless of the way of gripping, may be identified from a plurality of patterns. Accordingly, for example, it is possible to inform a user of whether the user's way of gripping a writing instrument is right or wrong, or to execute different functions with regard to the writing instrument according to the user's intended changes in the way of gripping the writing instrument.

According to embodiments of the present technology described above, it is possible to execute a proper process according to a user's way of gripping a writing instrument.

### BRIEF DESCRIPTION OF THE DRAWINGS

FIG. 1 is a diagram illustrating a schematic functional configuration of an information processing system according to a first embodiment of the present technology;

FIG. 2 is a diagram schematically illustrating the appearance of an electronic pen according to the first embodiment of the present technology;

FIG. 3 is a diagram illustrating examples of grip patterns defined in the first embodiment of the present technology;

FIG. 4 is a flowchart showing an example of a process of a terminal device according to the first embodiment of the present technology;

FIG. 5 is a diagram illustrating a modified example of the first embodiment of the present technology;

FIG. 6 is a diagram illustrating a schematic functional configuration of an information processing system according to a second embodiment of the present technology;

FIG. 7 is a diagram illustrating a display example of a learner's terminal according to the second embodiment of the present technology;

FIG. 8 is a diagram illustrating a configuration example of a learning system according to the second embodiment of the present technology;

FIG. 9 is a diagram illustrating a display example of a supervisor's terminal according to the second embodiment of the present technology;

FIG. 10 is a flowchart showing an example of a process of a terminal device according to the second embodiment of the present technology;

FIG. 11 is a diagram illustrating a modified example of the second embodiment of the present technology;

FIG. 12 is a diagram schematically illustrating the appearance of an electronic pen according to a third embodiment of the present technology;

FIG. 13 is a diagram illustrating examples of grip patterns defined in the third embodiment of the present technology;

FIG. 14 is a diagram illustrating examples of grip patterns defined in a fourth embodiment of the present technology;

FIG. 15 is a flowchart showing another process of the terminal device according to the fourth embodiment of the present technology;

FIG. 16 is a diagram illustrating examples of a writing instrument and a case according to a fifth embodiment of the present technology;

FIG. 17 is a diagram illustrating a schematic functional configuration of the writing instrument according to the fifth embodiment of the present technology;

FIG. 18 is a flowchart showing a process of an electronic pen according to the fifth embodiment of the present technology; and

FIG. 19 is a block diagram for describing a hardware configuration of an information processing apparatus.

### DETAILED DESCRIPTION OF THE EMBODIMENT(S)

Hereinafter, preferred embodiments of the present disclosure will be described in detail with reference to the appended drawings. Note that, in this specification and the appended drawings, structural elements that have substantially the same function and structure are denoted with the same reference numerals, and repeated explanation of these structural elements is omitted.

Note that description will be provided in the following order.

1. First embodiment
1-1. Functional configuration
1-2. Process flow
1-3. Modified example

2. Second embodiment
2-1. Functional configuration
2-2. Display example
2-3. Process flow
2-4. Modified example

3. Third embodiment

4. Fourth embodiment

5. Fifth embodiment

6. Hardware configuration

7. Supplemental remarks

### 1. First Embodiment

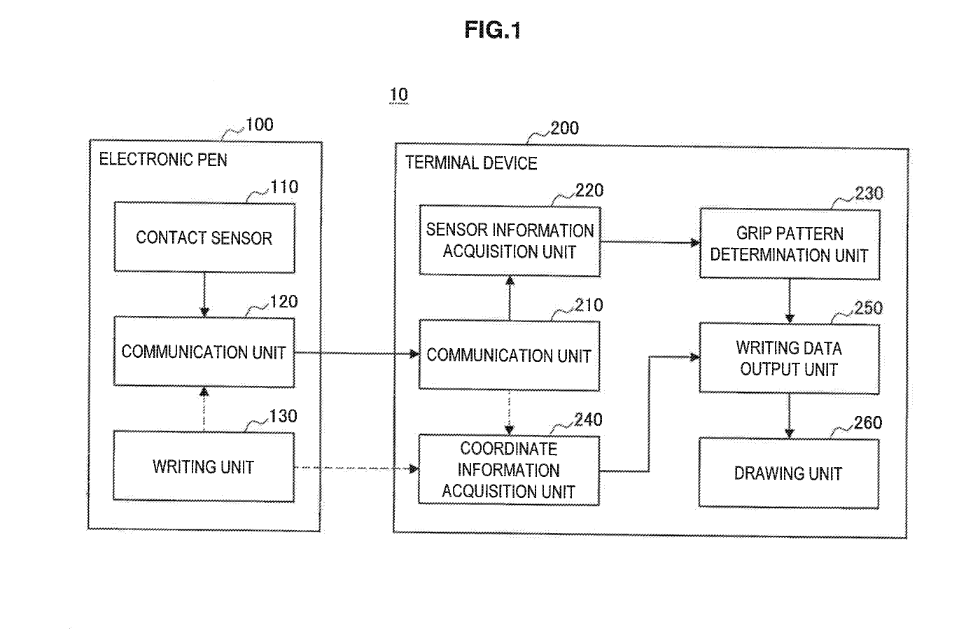

First, a first embodiment of the present technology will be described with reference to FIGS. 1 to 5.

### (1-1. Functional Configuration)

FIG. 1 is a diagram illustrating a schematic functional configuration of an information processing system according to the first embodiment of the present technology. When FIG. 1 is referred to, the information processing system 10 includes an electronic pen 100 and a terminal device 200. The electronic pen 100 and the terminal device 200 communicate with each other using various wired or wireless communication schemes.

### (Configuration of an Electronic Pen)

The electronic pen 100 includes a contact sensor 110, a communication unit 120, and a writing unit 130. The electronic pen 100 transmits a position on a surface to be written upon to the terminal device 200 using the function of the writing unit 130, detects contact of a finger with a surface thereof using the contact sensor 110, and provides the terminal device 200 with the detection result.

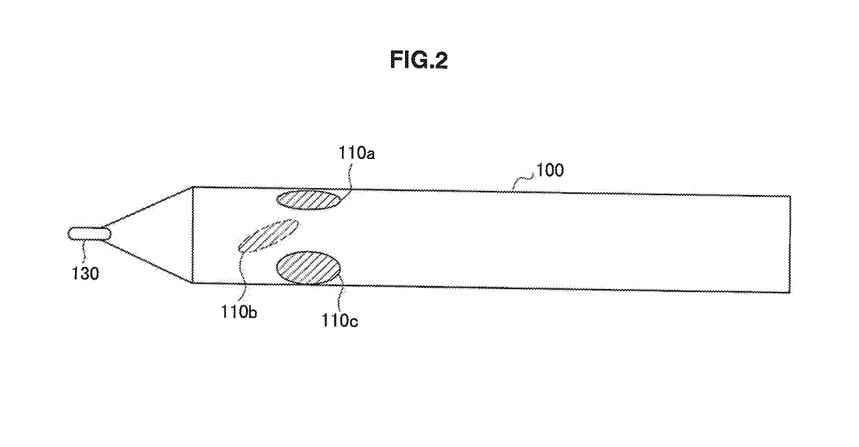

FIG. 2 is a diagram schematically illustrating the appearance of the electronic pen according to the first embodiment of the present technology. When FIG. 2 is referred to, three sensing points 110a to 110c of the contact sensor 110 are disposed on the surface of the electronic pen 100. The contact sensor 110 outputs sensor information including information indicating contact or non-contact of a finger with the three sensing points. The output sensor information is transmitted from the communication unit 120 to the terminal device 200.

Here, the sensing points 110a to 110c are disposed positions in which three fingers (the thumb, the index finger, and the middle finger) come into contact with the pen when the electronic pen 100 is gripped in a correct way of gripping. Based on the disposition of the sensing points 110a to 110c, whether or not a user is gripping the electronic pen 100 in a correct way of gripping, which will be described later, can be determined.

Meanwhile, the writing unit 130 is disposed at a tip end of the electronic pen 100 as illustrated in, for example. FIG. 2, and transmits the position of the electronic pen 100 on a surface to be written upon to the terminal device 200. The writing unit 130 is operated according to any one of various schemes, for example, an electromagnetic induction scheme, a resistive film scheme, an infrared and ultrasonic scheme, and an Anoto (registered trademark) scheme. Note that details of each scheme will not be described since the schemes are already well known.

A specific operation of the writing unit 130 differs depending on employed schemes. For example, the writing unit 130 may specify coordinate information indicating a position based on acquired information, and transmit the information to the terminal device 200 via the communication unit 120. Alternatively, the writing unit 130 may indirectly provide a coordinate information acquisition unit 240 of the terminal device 200 to be described later with information using, for example, pressure on a surface to be written upon, a change in a magnetic field on the surface to be written upon, emission of infrared rays or ultrasound, and the like, and the coordinate information acquisition unit 240 may specify coordinate information based on the received information.

### (Configuration of the Terminal Device)

The terminal device 200 includes a communication unit 210, a sensor information acquisition unit 220, a grip pattern determination unit 230, the coordinate information acquisition unit 240, a writing data output unit 250, and a drawing unit 260. The terminal device 200 may be, for example, a receiver attached to the electronic pen 100, or may be a general-purpose terminal device such as a personal computer or a smartphone. The terminal device 200 can be realized using, for example, the hardware configuration of an information processing apparatus to be described later. For example, the sensor information acquisition unit 220, the grip pattern determination unit 230, the writing data output unit 250, and the drawing unit 260 can be realized by an operation of a processor such as a CPU (Central Processing Unit) according to a program.

The communication unit 210 communicates with the communication unit 120 of the electronic pen 100, and receives various kinds of information. The communication unit 210 receives, for example, sensor information output from the contact sensor 110 of the electronic pen 100. In addition, when the writing unit 130 of the electronic pen 100 acquires coordinate information, the communication unit 210 also receives the coordinate information.

The sensor information acquisition unit 220 acquires sensor information from the communication unit 210. The sensor information is information output from the contact sensor 110 of the electronic pen 100 that detects contact of a finger with a surface of the pen as described above. In the present embodiment, the contact or non-contact with the three sensing points 110a to 110c is output as the sensor information as described with reference to FIG. 2.

The grip pattern determination unit 230 determines a grip pattern of a user gripping the electronic pen based on the sensor information. A grip pattern is defined by associating the user's way of gripping the electronic pen and the sensor information in advance. In the present embodiment, grip patterns are defined according to combinations of the contact or non-contact with the three sensing points 110a to 110c with the content of the sensor information.

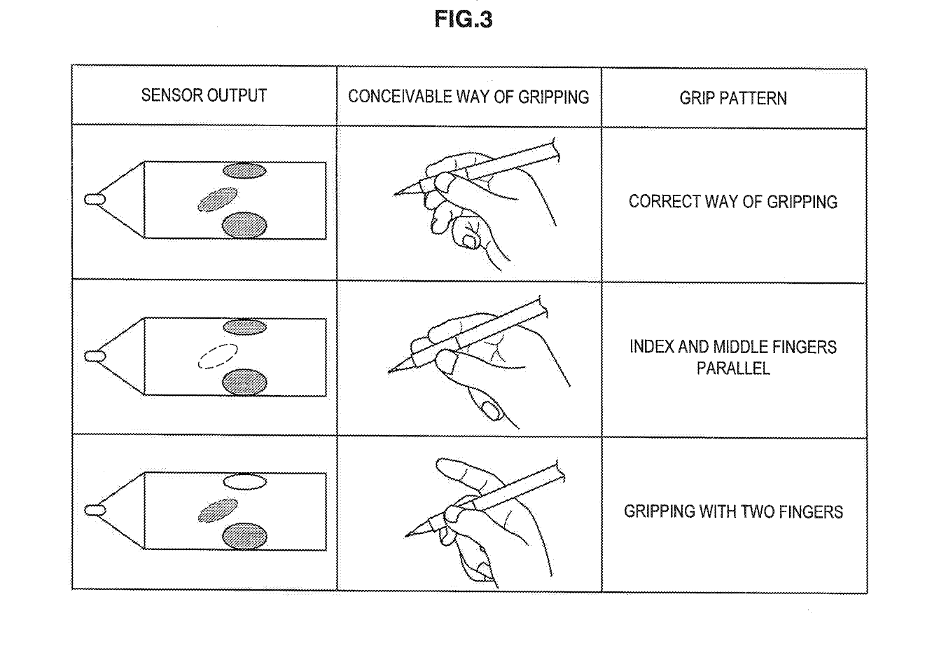

FIG. 3 is a diagram illustrating examples of grip patterns defined in the first embodiment of the present technology. When FIG. 3 is referred to, three grip patterns are defined in the present embodiment. A first grip pattern is a “correct way of gripping,” which is a so-called exemplary pattern. When the electronic pen 100 is gripped in the correct way of gripping, the sensing points 110a to 110c are disposed in the positions with which three fingers come in contact, as described with reference to FIG. 2. Thus, when a user grips the electronic pen 100 in the correct way of gripping, sensor information output from the contact sensor 110 should indicate that fingers come in contact with all of the three sensing points.

Meanwhile, a second grip pattern is an “index-and-middle-fingers-parallel” pattern. This pattern corresponds to sensor information indicating that fingers come in contact with two of the three sensing points, in other words, the sensing points 110a and 110c illustrated in FIG. 2, but no finger comes in contact with the remaining sensing point 110b. In this case, the user is assumed to be gripping the electronic pen 100 in a way of gripping that is generally incorrect, in which the index and middle fingers are parallel, as illustrated in FIG. 3.

In addition, a third grip pattern is a “gripping-with-two-fingers” pattern. This pattern corresponds to sensor information indicating that fingers come in contact with two different points of the three sensing points, in other words, the sensing points 110b and 110c illustrated in FIG. 2, but no finger conies in contact with the remaining sensing point 110a. In this case, the user is assumed to be gripping the electronic pen 100 with two fingers, i.e., the thumb and the middle fingers, as illustrated in FIG. 3. This way of gripping is generally incorrect.

Further, although three grip patterns are shown in the example illustrated in FIG. 3, when the contact or non-contact with the three sensing points is acquired as sensor information as in the present embodiment, a maximum of eight grip patterns can be defined. The settings of the grip patterns illustrated in FIG. 3 are merely examples, and various grip patterns can be set without being limited the examples.

As an example in which the grip pattern is set to the minimum, for example, only one grip pattern corresponding to the “correct way of gripping” may be defined. In this case, the grip pattern determination unit 230 simply determines whether or not a grip pattern indicated by sensor information corresponds to the “correct way of gripping.” Alternatively, two or more grip patterns may be defined. In this case, a grip pattern other than the “correct way of gripping” can be defined, for example, corresponding to a way of gripping that is highly likely to occur in actual life (a so-called “frequent mistaken way of gripping”).

In addition, the combinations of the contact or non-contact with each sensing point indicated by the sensor information do not necessarily have to be associated with the grip patterns one-to-one, and a plurality of combinations showing, for example, a similar tendency may be associated with the same grip pattern.

Referring to FIG. 1, again, the coordinate information acquisition unit 240 acquires coordinate information indicating a position of the electronic pen 100 on a surface to be written upon. A specific operation of the coordinate information acquisition unit 240 differs depending on operations of the writing unit 130 of the electronic pen 100 described above. When coordinate information is specified based on information acquired by the writing unit 130, for example, the coordinate information acquisition unit 240 acquires the coordinate information from the writing unit 130 via the communication unit 120 and the communication unit 210. Alternatively, the coordinate information acquisition unit 240 may be indirectly provided with information from the writing unit 130 using, for example, pressure on the surface to be written upon, a change in a magnetic field on the surface to be written upon, emission of infrared rays or ultrasound, and the like, and may specify the coordinate information based on the provided information.

Thus, there are cases in which the coordinate information acquisition unit 240 is realized by, for example, a processor of the terminal device 200, or includes a detection circuit or a receiving device that acquires information indirectly given from the writing unit 130. Alternatively, the coordinate information acquisition unit 240 may be a receiver of the electronic pen 100 externally attached to the general-purpose terminal device 200 such as a personal computer or a smartphone.

The writing data output unit 250 outputs writing data according to the coordinate information acquired by the coordinate information acquisition unit 240. To be more specific, the writing data output unit 250 outputs traces of the coordinate information expressed according to time-series changes as writing data. Here, the writing data output unit 250 outputs writing data when a grip pattern determined by the grip pattern determination unit 230 coincides with the pattern of the “correct way of gripping” illustrated in FIG. 3, in other words, the exemplary pattern. In other words, the writing data output unit 250 can be said to be a function execution unit that executes a predetermined function when a grip pattern coincides with the exemplary pattern.

The drawing unit 260 acquires the writing data output from the writing data output unit 250, and draws chirographic prints on a display unit (not illustrated) based on the data. The display unit may be a display that, for example, the terminal device 200 has as an output device, or may be a display that an external device connected to the terminal device 200 has.

### (1-2. Process Flow)

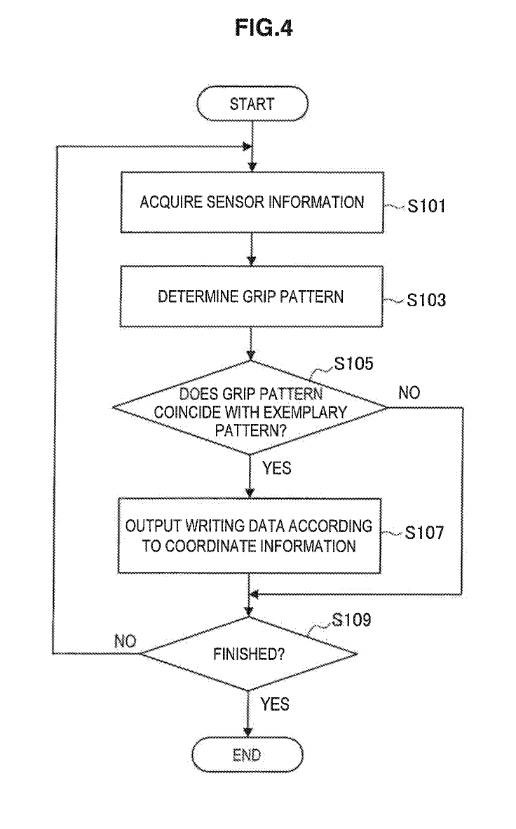

FIG. 4 is a flowchart showing an example of a process of the terminal device according to the first embodiment of the present technology.

First, the sensor information acquisition unit 220 of the terminal device 200 acquires sensor information from the electronic pen 100 via the communication unit 210 (Step S101). Next, the sensor information acquisition unit 220 provides the grip pattern determination unit 230 with the sensor information, and the grip pattern determination unit 230 determines a grip pattern based on the sensor information (Step S103).

Next, the grip pattern determination unit 230 provides the writing data output unit 250 with information on the determined grip pattern, and the writing data output unit 250 determines whether or not the grip pattern coincides with an exemplary pattern, that is, the pattern of the “correct way of gripping” (Step S105).

Here, when the grip pattern coincides with the exemplary pattern (YES), the writing data output unit 250 outputs writing data according to coordinate information acquired by the coordinate information acquisition unit 240 (Step S107).

On the other hand, when the grip pattern does not coincide with the exemplary pattern in Step S105 (NO), the writing data output unit 250 does not output the writing data even when the coordinate information is acquired by the coordinate information acquisition unit 240. The above processes are repeated until writing ends (Step S109).

As a result of the processes, when user is not gripping the electronic pen 100 in the “correct way of gripping,” the writing data output unit 250 does not output writing data and the drawing unit 260 does not draw chirographic prints on the display unit even when the user brings the writing unit 130 of the electronic pen 100 into contact with a surface to be written upon and moves the writing unit thereon.

Thus, the user recognizes that his or her way of gripping the electronic pen is not the “correct way of gripping” when viewing characters or figures which are supposed to be written with the electronic pen 100 not displayed on the display unit. In the present embodiment, by nullifying writing when a writing instrument is not correctly gripped as described above, the user is prompted to grip the writing instrument in the correct way of gripping.

### (1-3. Modified Example)

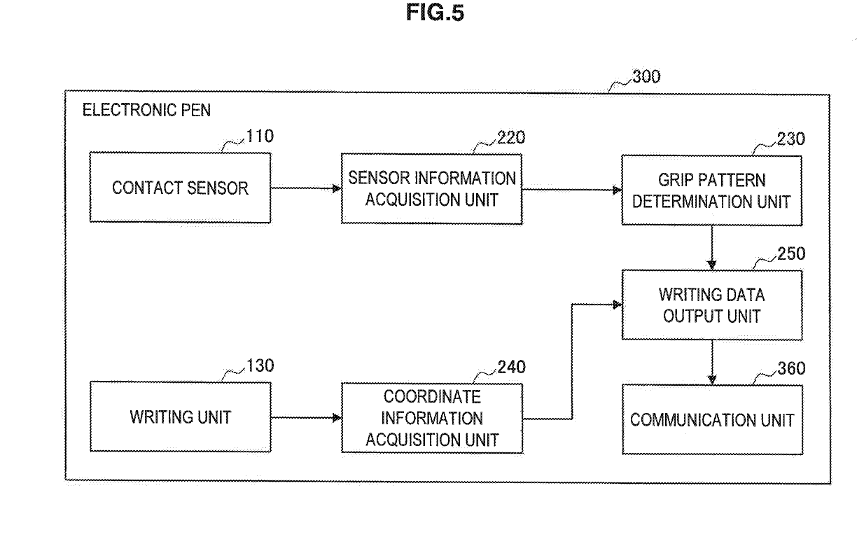

FIG. 5 is a diagram illustrating a modified example of the first embodiment of the present technology. As illustrated in FIG. 5, the functional configuration realized by the electronic pen 100 and the terminal device 200 in the example of FIG. 1 is realized by an electronic pen 300 in the present modified example. In the present modified example, the electronic pen 300 has a function of information processing as will be described below, and can be realized using, for example, a hardware configuration of an information processing apparatus to be described later.

The electronic pen 300 includes the contact sensor 110, the writing unit 130, the sensor information acquisition unit 220, the grip pattern determination unit 230, the coordinate information acquisition unit 240, the writing data output unit 250, and a communication unit 360. Except for the communication unit 360, the electronic pen 300 has the same constituent elements as those described with reference to FIG. 1 above. However, the contact sensor 110 internally provides the sensor information acquisition unit 220 with sensor information, and the writing unit 130 and the coordinate information acquisition unit 240 internally cooperate with each other to specify coordinate information.

The communication unit 360 transmits writing data output from the writing data output unit 250 to an external device (which can be, for example, a terminal device or a display device) having a drawing unit and a display unit. When the writing data output unit 250 does not output writing data due to the fact that a grip pattern does not coincide with the exemplary pattern, the writing data is not transmitted from the communication unit 360 to the external device, and thus chirographic prints are not drawn on the display unit of the external device.

In this manner, each embodiment of the present technology can also be realized by mounting a sensor information acquisition unit, a grip pattern determination unit, and a function execution unit in an electronic pen itself which is a writing instrument.

### 2. Second Embodiment

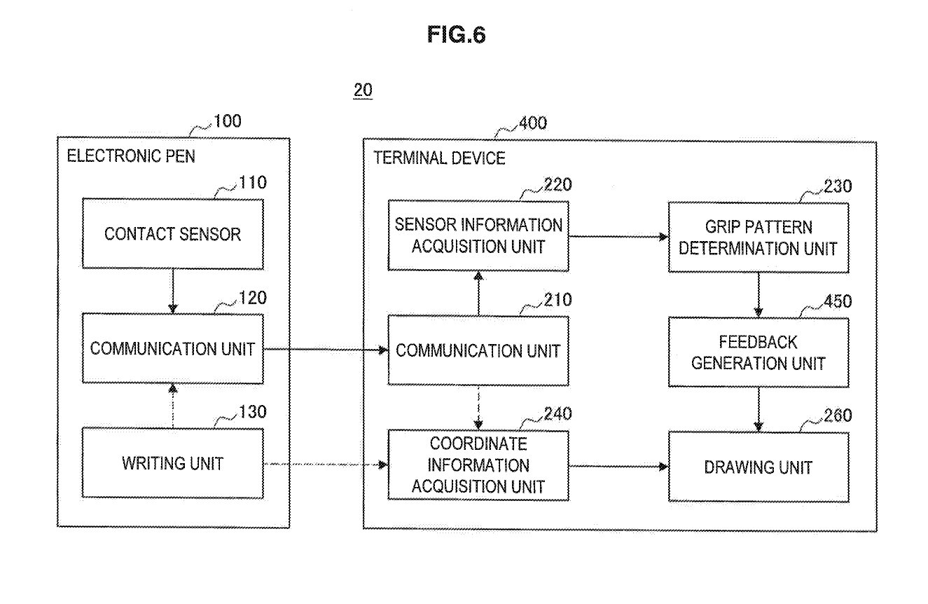

Next, a second embodiment of the present technology be described with reference to FIGS. 6 to 11.

### (2-1. Functional Configuration)

FIG. 6 is a diagram illustrating a schematic functional configuration of an information processing system according to the second embodiment of the present technology. When FIG. 6 is referred to, the information processing system 20 includes the electronic pen 100 and a terminal device 400. The electronic pen 100 and the terminal device 400 communicate with each other using various kinds of communication schemes. Note that, since the electronic pen 100 is the same as described with reference to FIG. 1 above, detailed description thereof will be omitted herein.

The terminal device 400 includes the communication unit 210, the sensor information acquisition unit 220, the grip pattern determination unit 230, the coordinate information acquisition unit 240, the drawing unit 260, and a feedback generation unit 450. The terminal device 400 may be, for example, a receiver attached to the electronic pen 100, or may be a general-purpose terminal device such as a personal computer or a smartphone. The terminal device 400 can be realized using, for example, a hardware configuration of an information processing apparatus to be described later. The sensor information acquisition unit 220, the grip pattern determination unit 230, the drawing unit 260, and the feedback generation unit 450 can be realized from operations of a processor such as a CPU according to a program.

The terminal device 400 has the same constituent elements as the terminal device 200 described with reference to FIG. 1 above, except for the feedback generation unit 450. However, the coordinate information acquisition unit 240 provides the drawing unit 260 with coordinate information regardless of a determination result obtained by the grip pattern determination unit 230, and the drawing unit 260 draws chirographic prints on a display unit based on writing data according to the provided coordinate information.

The feedback generation unit 450 generates feedback information on a user according to a grip pattern determined by the grip pattern determination unit 230. When, for example, a grip pattern determined by the grip pattern determination unit 230 does not coincide with the pattern of the “correct way of gripping” illustrated in FIG. 3, the feedback generation unit 450 generates and outputs feedback information indicating that the grip pattern is different from the exemplary pattern, in other words, that the user is not correctly gripping the electronic pen 100. In other words, the feedback generation unit 450 can be said to be a function execution unit that executes a predetermined function when a grip pattern does not coincide with the exemplary pattern.

in the illustrated example, the feedback information output by the feedback generation unit 450 is provided in the drawing unit 260. The drawing unit 260 draws characters or figures on the display unit (not illustrated) of the terminal device 400 based on the feedback information. Here, the display unit may be, for example, a display unit of a device used by a user using the electronic pen 100. In addition, when the user using the electronic pen 100 is a learner, characters or figures drawn by the learner may be set to be displayed on a display unit of a device used by his or her supervisor.

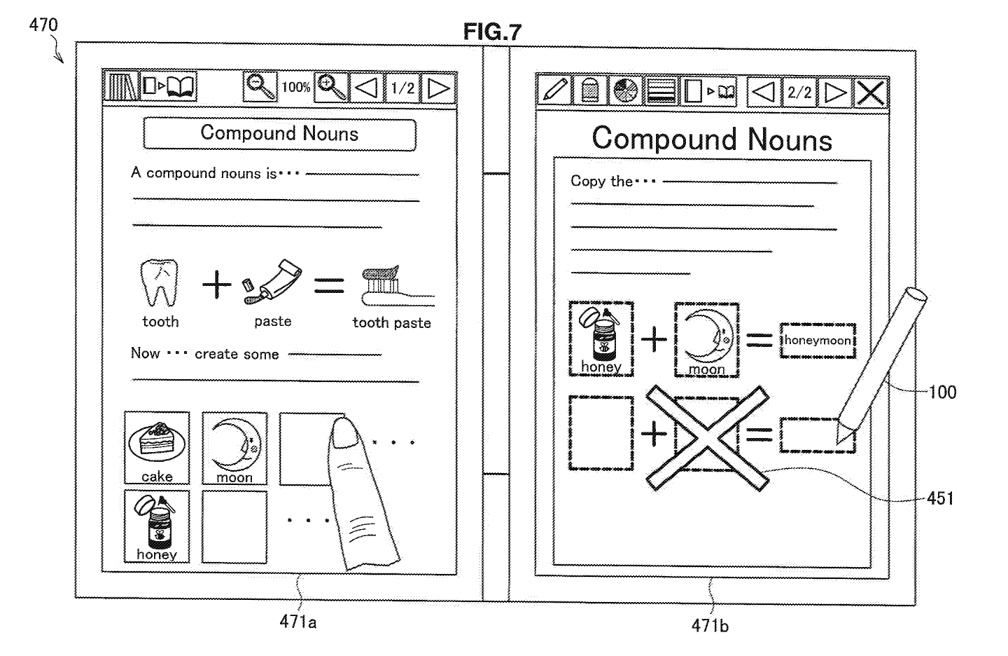

Hereinbelow, a specific example of display of the feedback information according to the present embodiment will be described with reference to FIGS. 7 to 9.

### (2-2. Display Example)

FIG. 7 is a diagram illustrating a display example of a learner's terminal according to the second embodiment of the present technology. When FIG. 7 is referred to, an icon 451 based on the feedback information is displayed on a display unit 471 of the learner's terminal 470 used by a user using the electronic pen 100. The learner's terminal 470 may be the same device as the terminal device 400 described above, or may be another device that receives information relating to the feedback information from the terminal device 400. Although the learner's terminal 470 has two display units 471a and 471b, and the icon 451 is displayed on the display unit 471b of the two units in the illustrated example, an embodiment of the present technology is not limited to the example. For example, the learner's terminal 470 may have a single display unit or three or more display units. In addition, the icon 451 may be displayed on some of a plurality of display units, or displayed on all of the units.

In addition, in the illustrated example, the icon 451 is displayed as a character or a figure based on the feedback information, but this is merely an example. Along with or instead of the icon 451, for example, text information may be displayed. The text information may indicate merely that a grip pattern of a user is different from the exemplary pattern, or may include detailed advice on correcting a way of gripping. For example, if “the nature of the user's error” is specified as the “index-and-middle-fingers-parallel” pattern, or the “gripping-with-two-fingers” pattern illustrated in FIG. 3, the content may be displayed as text information in detail. By displaying the information relating to the feedback information in the learner's terminal 470, the user who is learning using the electronic pen 100 can get information whether his way of gripping is right or wrong by himself.

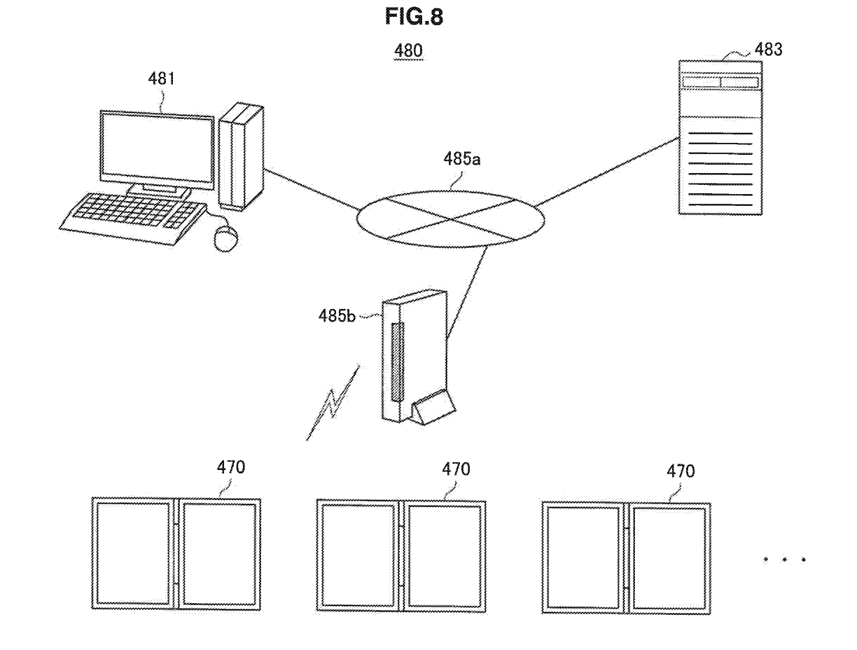

FIG. 8 is a diagram illustrating a configuration example of a learning system according to the second embodiment of the present technology. As illustrated in FIG. 8, the information relating to the feedback information may be displayed in any device in the learning system 480 including the learner's terminal 470 and a supervisor's terminal 481. The learning system 480 includes, for example, learner's terminal 470 used by each of a plurality of learners and a supervisor's terminal 481 used to supervise the learners, and the terminals are connected to each other via a network 485. The network 485 includes, for example, the Internet 485a and an access point 485b that each learner's terminal 470 accesses using a wireless communication scheme such as Wi-Fi (Wireless Fidelity: registered trademark). In addition, the learning system 480 may include a server 483 that provides each terminal with services.

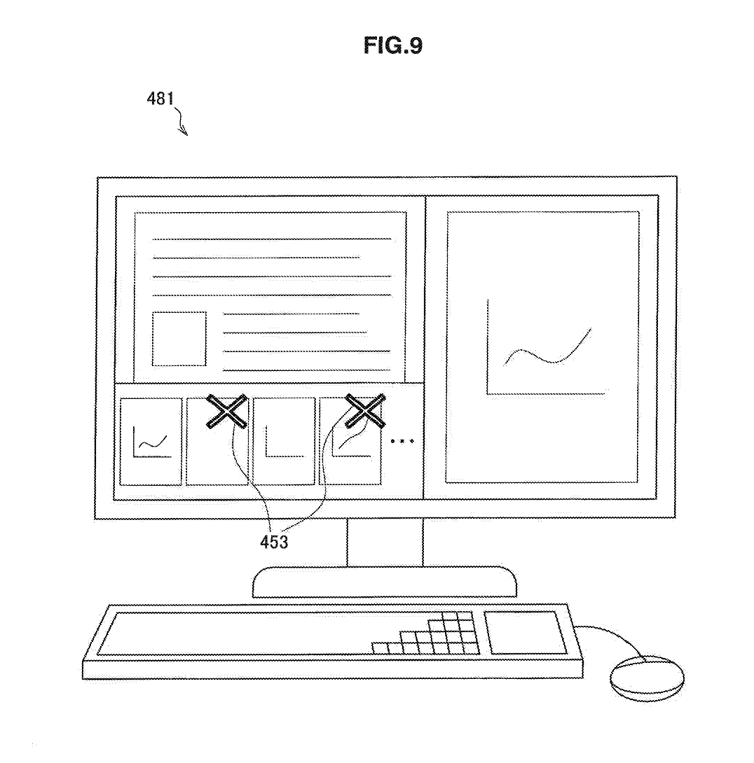

In the learning system 480, the information relating to the feedback information may be displayed, for example, in the learner's terminal 470 as illustrated in the example of FIG. 7 above, or may be displayed in the supervisor's terminal 481 together with or instead of the display in the learner's terminal. FIG. 9 illustrates a display example in the supervisor's terminal 481. The supervisor's terminal 481 is a terminal used by a teacher who teaches content to learners who are students. In such a case, when icons 453 are displayed in the supervisor's terminal 481 based on feedback information, the teacher can easily recognize which student is gripping the electronic pen 100 wrong.

Note that an example of a configuration and an operation more specific than the learning system 480 is disclosed in, for example, Japanese Unexamined Patent Application Publication No. 2012427989, and the like. In such a learning system 480, for example, realization of the function of the terminal device 400 by any one of the learner's terminal 470, the supervisor's terminal 481, or the server 483 and display of the information relating to the feedback information in the learner's terminal 470, the supervisor's terminal 481, or both terminals help mere learning of lessons and learning of the correct way of gripping of a writing instrument as well.

### (2-3. Process Flow)

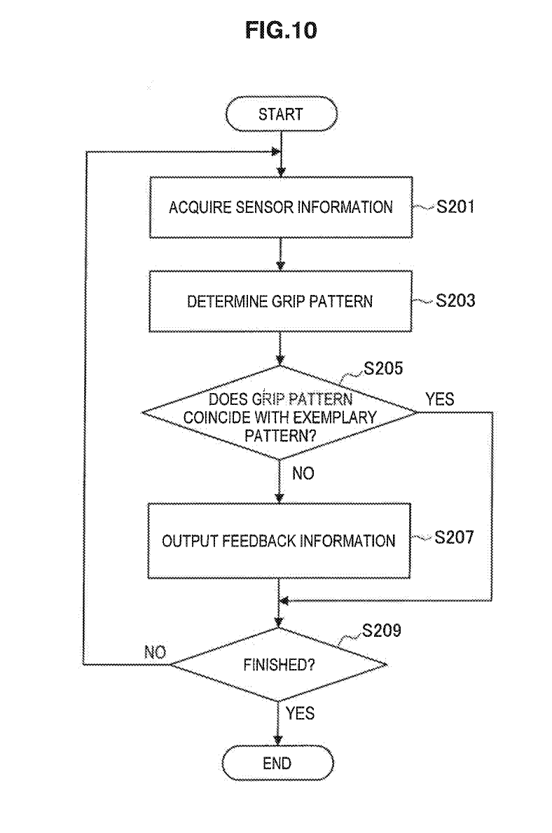

FIG. 10 is a flowchart showing an example of a process of the terminal device according to the second embodiment of the present technology.

First, the sensor information acquisition unit 220 of the terminal device 400 acquires sensor information from the electronic pen 100 via the communication unit 210 (Step S201). Next, the sensor information acquisition unit 220 provides the grip pattern determination unit 230 with the sensor information, and the grip pattern determination unit 230 determines a grip pattern based on the sensor information (Step S203).

Next, the grip pattern determination unit 230 provides the feedback generation unit 450 with information on the determined grip pattern, and the feedback generation unit 450 determines whether or not the grip pattern coincides with the exemplary pattern, that is, the “correct way of gripping” (Step S205).

Here, when the grip pattern does not coincide with the exemplary pattern (NO), the feedback generation unit 450 outputs feedback information (Step S207). As described above, the feedback information output here may merely indicate that, for example, the grip pattern of the user is different from the exemplary pattern, or may include detailed advice on correcting the way of gripping.

Note that the feedback info information may be output to the drawing unit 260 of the terminal device 400, or may be output to an external device having a display unit via the communication unit. As a result, for example, information indicating that the grip pattern of the user is different from the exemplary pattern can be displayed on the display unit of the learner's terminal, the supervisor's terminal, or the like.

On the other hand, when the grip pattern coincides with the exemplary pattern in Step S205 (YES), the feedback generation unit 450 does not output feedback information. Further, coordinate information acquired by the coordinate information acquisition unit 240 is provided to the drawing unit 260, and the drawing unit 260 draws chirographic prints on the display unit based on writing data according to the provided coordinate information. Thus, the user can continue writing without receiving feedback. The above processes are repeated until the writing ends (Step S209).

As a result of the processes, when the user is not gripping the electronic pen 100 in the “correct way of gripping,” feedback indicating the information is provided to the user himself, or another user who supervises learning of the user.

Thus, the user or another user can recognize that the way of gripping of the electronic pen 100 is not the “correct way of gripping.” Further, since drawing of a character or a figure using the electronic pen 100 continues regardless of the way of gripping of the electronic pen 100, the user can be prompted to grip the writing instrument in the correct way of gripping using a reasonable measure even in a case, for example, in which the user would be highly likely to feel discomfort due to the electronic pen 100 not functioning.

### (2-4. Modified Example)

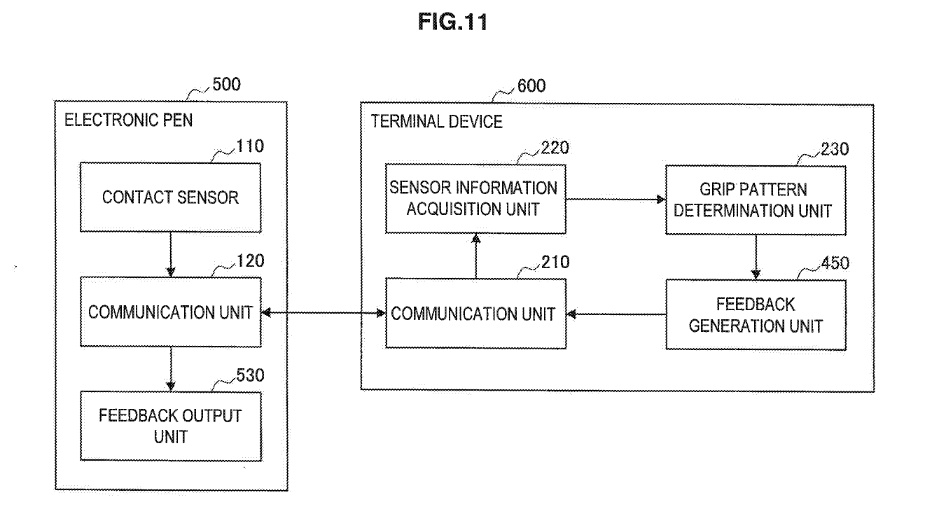

FIG. 11 is a diagram illustrating a modified example of the second embodiment of the present technology. As illustrated in FIG. 11, the functional configuration realized by the electronic pen 100 and the terminal device 400 in FIG. 6 is realized by a pen 500 and a terminal device 600 in the present modified example. Note that a system including the pen 500 and the terminal device 600 is set to be an information processing system 30.

The pen 500 includes the contact sensor 110, the communication unit 120, and a feedback output unit 530. As a difference from the electronic pen 100 described hitherto, the pen 500 does not necessarily acquire writing data of a user in an electronic manner. In other words, the pen 500 can be a writing instrument having a non-electronic writing unit (not illustrated) that is used to write chirographic prints of a user on a surface to be written upon such as paper using ink or graphite. However, the pen 500 has the contact sensor 110 on its surface in the same manner as the electronic pen 100, and transmits sensor information output from the contact sensor 110 to the terminal device 600 via the communication unit 120.

The terminal device 600 includes the communication unit 210, the sensor information acquisition unit 220, the grip pattern determination unit 230, and the feedback generation unit 450. As a difference from the terminal device 400 described with reference to FIG. 6, the terminal device 600 does not necessarily include the coordinate information acquisition unit 240. This is consistent with the fact that the pen 500 does not necessarily have an electronic writing unit. Thus, when the pen 500 has an electronic writing unit, the terminal device 600 can also include the coordinate information acquisition unit 240. In addition, the feedback generation unit 450 transmits generated feedback information to the pen 500 via the communication unit 210.

In the present modified example, when a grip pattern determined by the grip pattern determination unit 230 does not coincide with the exemplary pattern, feedback information output from the feedback generation unit 450 is transmitted to the pen 500, and provided to the feedback output unit 530. The feedback output unit 530 is a device of the pen 500 outputting information to a user, and can be, for example, a vibrator that vibrates the main body of the pen 500, a lamp that emits light, a speaker that outputs sound, or the like. When the user is not gripping the pen 500 in the “correct way of gripping,” the feedback output unit 530 can, for example, vibrate the main body of the pen 500, turn the lamp on, (or conversely, may turn the lamp off when the pen is not gripped in the correct way of gripping), or cause the speaker to output alarm sound.

According to the configuration of the modified example, an embodiment of the present technology can also be applied to anon-electronic writing instrument. As a substitute configuration, the terminal device 600 may have the drawing unit 260. In such a case, the feedback generation unit 450 transmits feedback information to the pen 500, and together with or instead of the transmission, the feedback information is provided to the drawing unit 260. Accordingly, when the pen 500 is a non-electronic writing instrument, for example, information relating to the feedback information can be displayed on a display unit of a device used by the user himself or herself or used by another user who supervises learning of the user. In this case, the pen 500 may not necessarily have the feedback output unit 530.

### 3. Third Embodiment

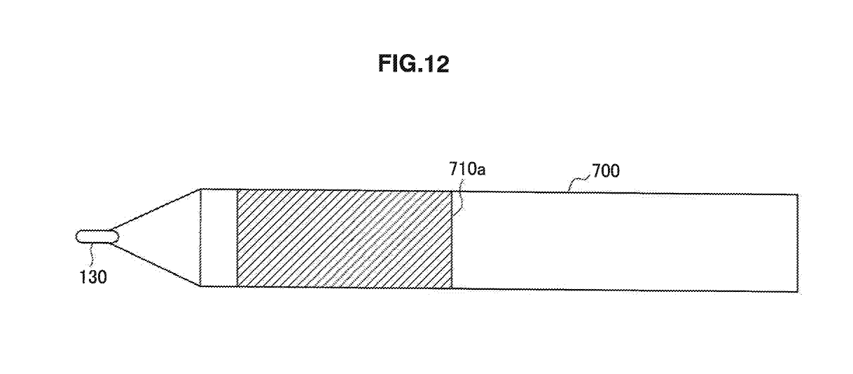

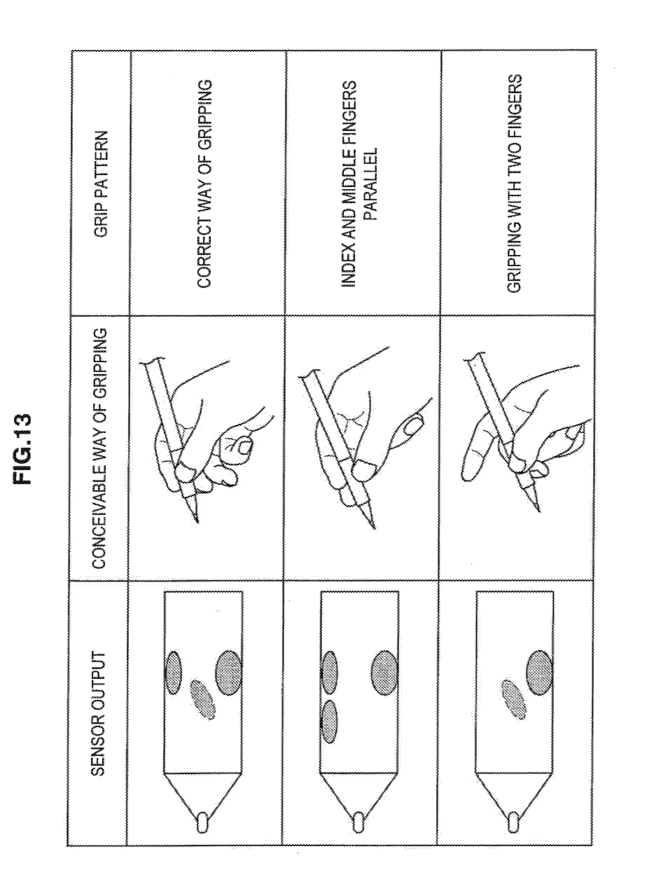

Next, a third embodiment of the present technology will be described with reference to FIGS. 12 and 13. The present embodiment has a different configuration of a contact sensor provided in a writing instrument from that of the first and the second embodiments described above. Part of the configuration shown as the first embodiment will be referred to as the configuration other than the contact sensor hereinbelow, but the reference is not limited thereto, and, for example, configurations of other embodiments and the modified examples thereof described in the present specification are applicable in the same manner.

FIG. 12 is a diagram schematically illustrating the appearance of an electronic pen according to the third embodiment of the present technology. When FIG. 12 is referred to, a sensing area 710a of the contact sensor is disposed on a surface of the electronic pen 700. The contact sensor outputs sensor information that includes information indicating the shape of a contact area of a finger in the sensing area 710a. Note that processes during and after transmission of the output sensor information to a terminal device via a communication unit are the same as in the embodiments described above and the modified example thereof.

Here the sensing area 710a is disposed in a position with which fingers of a user come in contact when the electronic pen 700 is gripped in the correct way of gripping. From the disposition of the sensing area 710a, it is possible to determine the grip pattern in which a user grips the electronic pen 700 as will be described later.

FIG. 13 is a diagram illustrating examples of grip patterns defined in the third embodiment of the present technology. When FIG. 13 is referred to, the same three grip patterns as in the example described with reference to FIG. 3 above are defined in the present embodiment. Each grip pattern can be defined as a pattern of a contact area of fingers in the sensing area 710a. For example, the “correct way of gripping” of the first grip pattern is a pattern in which fingers come into contact with three areas of both sides of the electronic pen 700 and approximately the middle of the sides. In addition, the “index-and-middle-fingers-parallel” of the second grip pattern is a pattern in which fingers come into contact with three areas of two spots on one side of the electronic pen 700 and one spot on the other side. “Gripping-with-two-fingers” of the third grip pattern is a pattern in which fingers come into contact with two areas of one side of the electronic pen 700 and approximately the middle thereof.

In the present embodiment, it is possible to recognize the shape of the contact areas of fingers in the entire sensing area 710a. Thus, when no finger comes into contact with any one of the three areas defined in the pattern of the “correct way of gripping,” for example, it is possible to identify whether the finger in no contact with an area comes into contact with another area on the surface of the electronic pen 700, or whether the finger comes into contact with no area. In other words, in the sensing point method illustrated in FIG. 2, it is uncertain where the finger in no contact with the predetermined sensing points is positioned, but the position of the finger can be identified in the present embodiment. In addition, since a contact area of a finger in an arbitrary shape can be recognized in the present embodiment, there is no limitation on the number of definable grip patterns.

Further, in the present embodiment, for example, a pattern matching process is executed on contact areas of fingers indicated in sensor information and contact areas of the fingers associated with the predefined grip patterns by the grip pattern determination unit (note that, since the pattern matching process on two-dimensional shapes is a related art, details thereof will not be described). More various grip patterns can be defined than in the sensing point method, and accordingly, the process of determining a grip pattern becomes complicated. Thus, in an embodiment of the present disclosure, the disposition of the contact sensor in a writing instrument can be decided considering, for example, to what extent a grip pattern should be specifically determined, to what extent a processing burden will be tolerable, or the like.

In addition, a sensor provided in a writing instrument in an embodiment of the present technology is not limited to the contact sensor as described hitherto in the embodiments. A sensor provided in a writing instrument may be, for example, a temperature sensor, or the like as long as it can detect contact of a finger with a surface of a writing instrument. In addition to a sensor detecting contact of a finger with a surface of a writing instrument, the sensor may be a pneumatic sensor that can detect contact pressure of each finger, or the like. In this case, grip patterns can be defined based on information of which finger comes into contact at what level of pressure, whether contact pressure of each finger is even or uneven, or the like, in addition to information of contact positions of fingers as illustrated in, for example, FIGS. 3 and 13.

In such a case, when the distribution of contact pressure of fingers is different from that in the exemplary pattern even though the contact positions of the fingers coincide with those in the exemplary pattern, for example, a user may be provided with feedback indicating that, for example, force of the fingers is unevenly distributed, without determining that the writing instrument is being gripped in the correct grip pattern. With this configuration, the user can be prompted, for example, to grip the writing instrument in a way closer to the exemplary pattern.

### 4. Fourth Embodiment

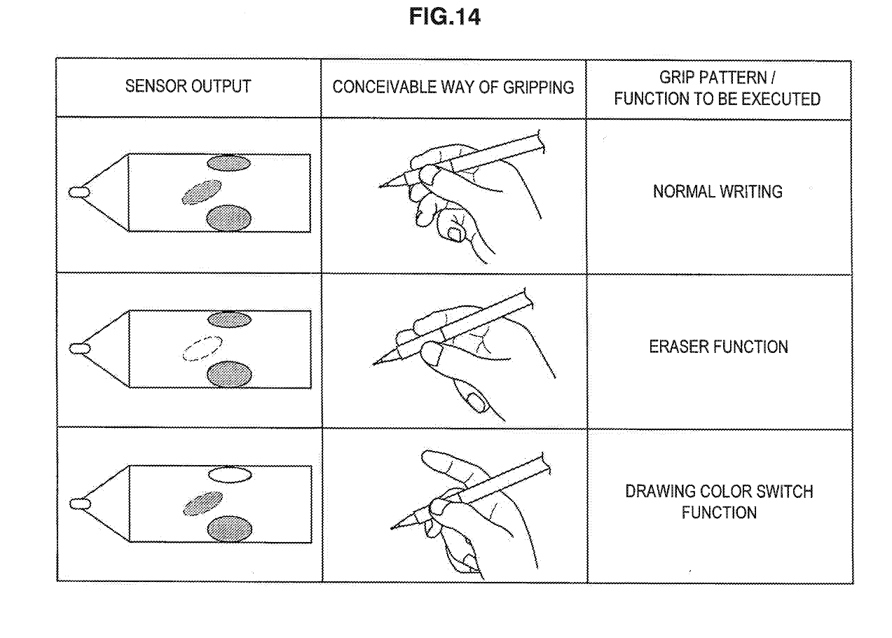

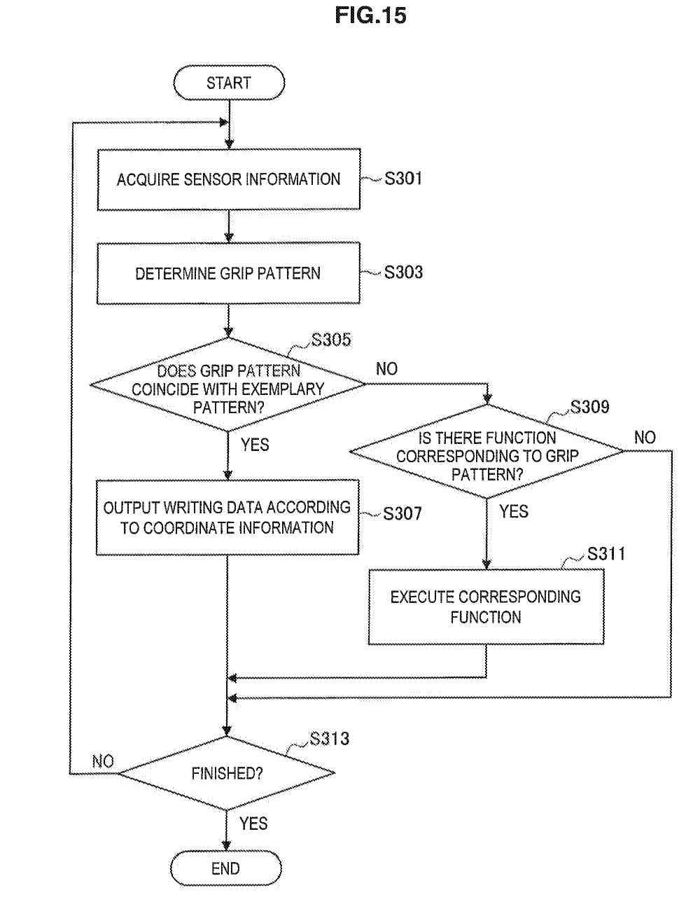

Next, a fourth embodiment of the present disclosure will be described with reference to FIGS. 14 and 15. The present embodiment has different configurations of grip patterns to be determined and the function execution unit that executes a function accordingly from those in the first to the third embodiments described above. Part of the configuration shown as the first embodiment will be referred to as the configuration other than the configurations hereinbelow, but the reference is not limited thereto, and, for example, configurations of other embodiments and the modified examples thereof described in the present specification are applicable in the same manner.

FIG. 14 is a diagram illustrating examples of grip patterns defined in the fourth embodiment of the present technology. When FIG. 14 is referred to, three grip patterns of a first grip pattern that is the exemplary pattern, and second and third grip patterns are defined in the same manner as the example described with reference to FIG. 3 above. However, meanings given to the grip patterns are different from the example of FIG. 3. In the example of FIG. 14, the grip patterns are associated with different functions, and a function corresponding to a recognized grip pattern is executed by the function execution unit.

To be specific, the function associated with the first pattern is “normal writing.” When a grip pattern corresponds to the first pattern, writing data is output according to coordinate information indicating a position of a writing instrument on a surface to be written upon. The function associated with the second pattern is an “eraser function.” When a grip pattern corresponds to the second pattern, according to coordinate information indicating a position of a writing instrument on a surface to be written upon, the eraser function of erasing a part of characters or figures written in the position is executed. The function associated with the third pattern is a “drawing color switch function.” When a grip pattern corresponds to the third pattern, a color drawn when writing data is output is changed.

FIG. 15 is a flowchart showing another process of the terminal device according to the fourth embodiment of the present technology.

First, the sensor information acquisition unit 220 of the terminal device 200 acquires sensor information from the electronic pen 100 via the communication unit 210 (Step S301). Next, the sensor information acquisition unit 220 provides the grip pattern determination unit 230 with the sensor information, and the grip pattern determination unit 230 determines a grip pattern based on the sensor information (Step S303).

Next, the grip pattern determination unit 230 provides the writing data output unit 250 with information on the determined grip pattern, and the writing data output unit 250 determines whether or not the grip pattern coincides with the exemplary pattern (the first pattern illustrated in FIG. 14) (Step S305).

Here; when the grip pattern coincides with the exemplary pattern (YES), the writing data output unit 250 outputs writing data according to coordinate information acquired by the coordinate information acquisition unit 240 (Step S307).

On the other hand, when the grip pattern does not coincide with the exemplary pattern in Step S305 (NO), the writing data output unit 250 further determines whether or not there is a function corresponding to the grip pattern (Step S309). With regard to the case illustrated in FIG. 14, for example, the determination can be the determination on whether or not the grip pattern coincides with any of the second or the third grip pattern.

Here, when there is a function corresponding to the grip pattern (YES), the writing data output unit 250 executes the corresponding function (Step S311). In the case illustrated in FIG. 14, individually executed functions are the “eraser function” or the “painted color switch function.”

On the other hand, when there is no function corresponding to the grip pattern in Step S309 (NO), the writing data output unit 250 finishes the process without executing the function. In other words, when the electronic pen 100 is gripped in a pattern other than the predefined grip patterns, other functions are not executed either without outputting the writing data. The above processes are repeated until writing ends (Step S313).

In this manner, in the present embodiment, the grip patterns are used for switching the functions to be executed. The flowchart shown in FIG. 15 is described based on the configuration of the first embodiment, however, an embodiment of the present technology is not limited thereto. For example, a function executed by being switched according to the grip patterns is not limited to a function executed by the writing data output unit 250 that is the function execution unit of the first embodiment. The function execution unit may be, for example, the feedback generation unit 450 shown in the second embodiment, or another function execution unit that executes a different function from the unit.

By using the grip patterns for switching the functions to be executed, a user can execute a desired function holding a writing instrument. In addition, when a grip pattern of the user is different from the exemplary pattern even though he or she wants to use the “normal writing,” for example, an effect of making the user aware of using a wrong way of gripping can also be expected by executing the unintended “eraser function” or “drawing color switch function.”

### 5. Fifth Embodiment

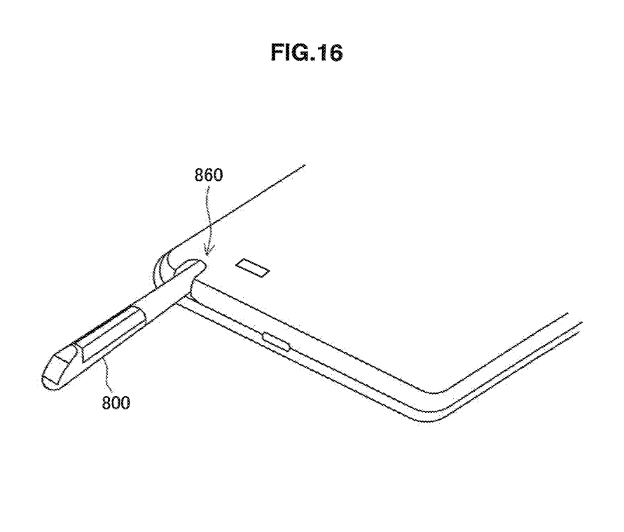

Next, a fifth embodiment of the present technology will be described with reference to FIGS. 16 to 18. As an additional configuration of the present embodiment to the embodiments described above, a sensor or a communication unit of a writing instrument is activated when the writing instrument is taken out from a case. Part of the configuration shown as the first embodiment will be referred to as the configuration other than the additional configuration hereinbelow, but the reference is not limited thereto, and, for example, configurations of other embodiments and the modified examples thereof described in the present specification are applicable in the same manner.

FIG. 16 is a diagram illustrating examples of a writing instrument and a case according to the fifth embodiment of the present technology. As illustrated in FIG. 16, in the present embodiment, an electronic pen 800 which is the writing instrument is housed in the case 860. Note that the case 860 may not necessarily be integrally formed with a terminal device as in the example illustrated in the drawing, and may be formed, for example, independently of a terminal device.

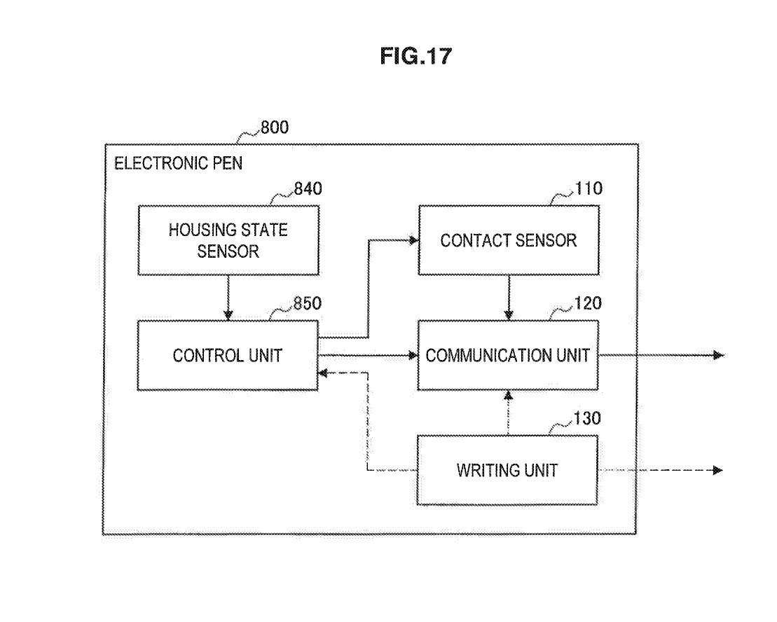

FIG. 17 is a diagram illustrating a schematic functional configuration of the writing instrument according to the fifth embodiment of the present technology. When FIG. 17 is referred to, the electronic pen 800 has the contact sensor 110, the communication unit 120, the writing unit 130, a housing state sensor 840, and a control unit 850.

Since the contact sensor 110, the communication unit 120, and the writing unit 130 are the same constituent elements as those of the electronic pen 100 described with reference to FIG. 1, detailed description thereof will be omitted herein. Note that, instead of the same constituent elements as the electronic pen 100 in the illustrated example, the electronic pen 800 may have the same constituent elements as, for example, the electronic pen 300 described with reference to FIG. 5, or the pen 500 described with reference to FIG. 11. In other words, as long as the control unit 850 to be described below can execute control of the sensor or the communication unit, other constituent elements of the writing instrument can be arbitrarily set.

The housing state sensor 840 detects that the electronic pen 800 is taken out from the case 860. The housing state sensor 840 can be, for example, a switch provided in the position in which the electronic pen 800 comes into contact with the case 860. In addition, the housing state sensor 840 may also serve as the contact sensor 110. In this case, when a contact provided in the case 860 is not in contact with a predetermined position of the contact sensor 110 (which may be the housing state sensor 840), the electronic pen 800 is detected to be taken out from the case 860.

The control unit 850 is realized by, for example, a micro controller, and controls one or both of the contact sensor 110 and the communication unit 120 according to a detection result of the housing state sensor 840. When the electronic pen 800 has a processor such as a CPU as the electronic pen 300 described with reference to FIG. 5, for example, the function of the control unit 850 may be realized by the processor. The control unit 850 may control one or both of the contact sensor 110 and the communication unit 120 according to a detection result of the writing unit 130. Detailed control by the control unit 850 will be described with reference to a flowchart hereinbelow.

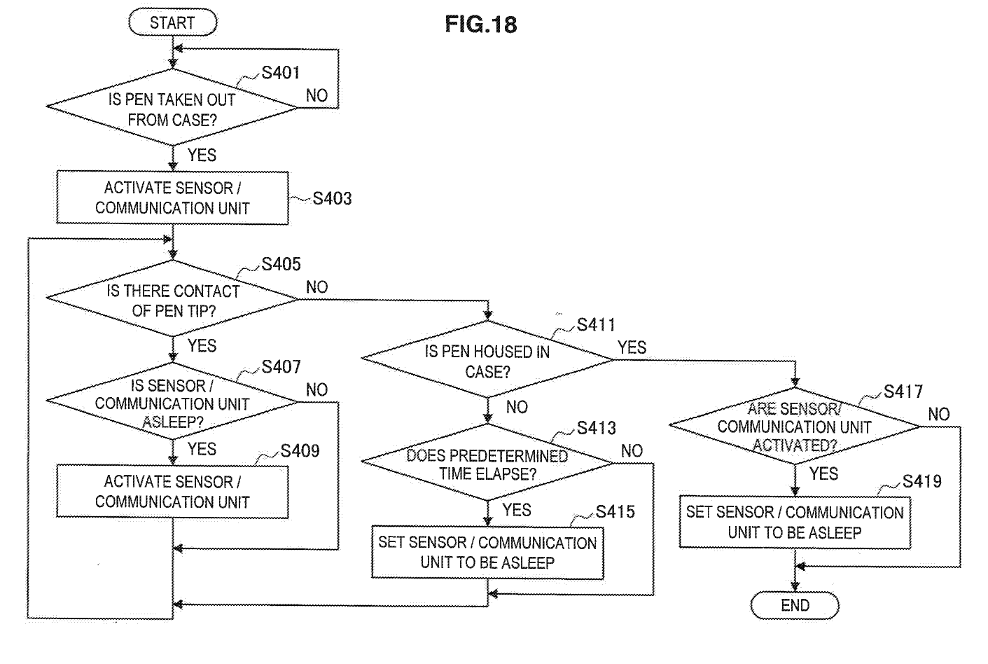

FIG. 18 is the flowchart showing a process of the electronic pen according to the fifth embodiment of the present technology.

In the example of the flowchart, the process starts from the state in which the electronic pen 800 is housed in the case 860. The control unit 850 acquires a detection result of the housing state sensor 840, and continuously determines whether the electronic pen 800 is taken out from the case 860 (Step S401).

Here, when the electronic pen 800 is taken out from the case 860 (YES), the control unit 850 activates one or both of the contact sensor 110 and the communication unit 120 (Step S403). When the electronic pen 800 is not taken out from the case 860 (NO), the control unit 850 continues the determination of Step S401.

When the housing state sensor 840 is a different sensor from the contact sensor 110, for example, the control unit 850 activates both of the contact sensor 110 and the communication unit 120 in Step S403. In other words, in such a case, the contact sensor 110 and the communication unit 120 are not activated while the electronic pen 800 is housed in the case 860.

On the other hand, when the housing state sensor 840 also serves as the contact sensor 110, the control unit 850 activates the communication unit 120 in Step S403. In other words, in such a case, the contact sensor 110 is also activated while the electronic pen 800 is housed in the case 860 since the contact sensor also functions as the housing state sensor 840. The communication unit 120 is not activated while the electronic pen 800 is housed in the case 860.

Next, the control unit 850 determines whether or not the pen tip of the electronic pen 800 comes into contact with a surface to be written upon based on information acquired by the writing unit 130 (Step S405). When the determination is executed, the writing unit 130 has a switch detecting, for example, contact of the pen tip with the surface to be written upon. Alternatively, the control unit 850 may determine whether or not the pen tip of the electronic pen 800 comes into contact with the surface to be written upon based on coordinate information acquired in cooperation with the writing unit 130 and the coordinate information acquisition unit 240 of the terminal device 200.

Note that Step S405 described above is an additionally executed step. Thus, the writing unit 130 does not have to provide the control unit 850 with the information on contact of the pen tip. When the determination of Step S405 is not executed, the process proceeds to Step S411 as is.

When the pen tip is determined to come into contact with the surface to be written upon in Step S405 (YES), the control unit 850 further determines whether or not one or both of the contact sensor 110 and the communication unit 120 are asleep (Step S407). Note that the contact sensor 110 and the communication unit 120 are set to be asleep with the process of Step S415 to be described later when a predetermined time elapses in the state of non-contact of the pen tip with the surface to be written upon.

Here, when one or both of the contact sensor 110 and the communication unit 120 are asleep (YES), the control unit 850 activates the sleeping contact sensor 110 or communication unit 120 (Step S409). When neither is asleep (NO), since the contact sensor 110 and the communication unit 120 are already activated, the control unit 850 does nothing. After that, the process returns to Step S405.

On the other hand, when the pen tip does not comes into contact with the surface to be written upon in Step S405 (NO), the control unit 850 acquires a detection result of the housing state sensor 840, and determines whether or not the electronic pen 800 is housed in the case 860 (Step S411).

Here, when the electronic pen 800 is determined not to be housed in the case 860 (NO), the control unit 850 further determines whether or not a predetermined time elapses in the state of non-contact of the pen tip of the electronic pen 800 with the surface to be written upon (Step S413). Here, when the predeterminded time elapses (YES), it is presumed that the user pauses writing, and thus the control unit 850 sets one or both of the contact sensor 110 and the communication unit 120 to be asleep (Step S415).

On the other hand, when the predetermined time does not elapse in Step S413 (NO), it is presumed that the user is highly likely to resume writing, and thus the control unit 850 stands by with the contact sensor 110 and the communication unit 120 activated. Then, the process returns to Step S405.

On the other hand, when the electronic pen 800 is determined to be housed in the case 860 in Step S411 (YES), the control unit 850 determines whether or not the contact sensor 110 and the communication unit 120 are activated (Step S417), and when they are activated (YES), one or both of the contact sensor 110 and the communication unit 120 are set to be asleep (Step S419).

Here, whether or not the contact sensor 110 is set to be asleep is decided based on, for example, whether the housing state sensor 840 and the contact sensor 110 are different sensors as described above. When the housing state sensor 840 also serves as the contact sensor 110, since the contact sensor 110 should be used when the processes of the next round start (in other words, the next time Step S401 is executed), the contact sensor is not set to be asleep.

In the present embodiment, when the writing instrument is housed in the case, or when the pen tip thereof does not come into contact with the surface to be written upon even though the writing instrument is taken out from the case, at least one of the contact sensor and the communication unit is set to be asleep with the above processes. Accordingly, unnecessary power consumption by such a constituent element can be suppressed.

### (6. Hardware Configuration)

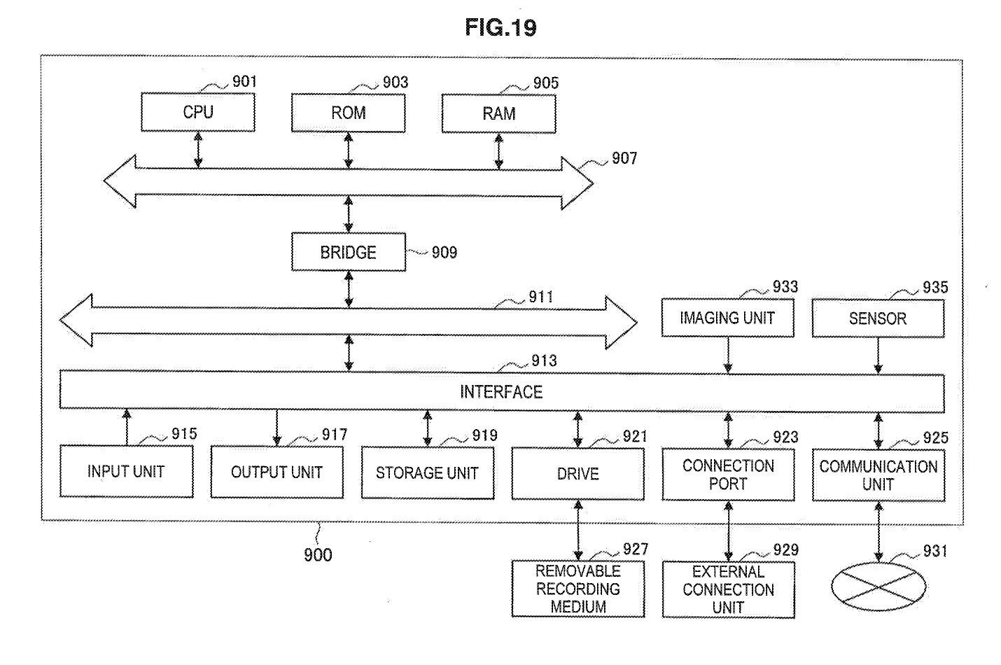

Next, a hardware configuration of an information processing apparatus according to an embodiment of the present technology will be described with reference to FIG. 19. FIG. 19 is a block diagram for describing the hardware configuration of the information processing apparatus. The illustrated information processing apparatus 900 can realize, for example, the terminal devices 200, 400, and 600, the electronic pen 300, the learner's terminal 470, the supervisor's terminal 481, the server 483, and the like in the embodiments described above.

The information processing apparatus 900 includes a CPU (Central Processing Unit) 901, a ROM (Read Only Memory) 903, and a RAM (Random Access Memory) 905. In addition, the information processing apparatus 900 may include a host bus 907, a bridge 909, an external bus 911, an interface 913, an input unit 915, an output unit 917, a storage unit 919, a drive 921, a connection port 923, and a communication unit 925. Further, the information processing apparatus 900 may include an imaging unit 933 and a sensor 935 as necessary. The information processing apparatus 900 may include a processing circuit such as a DSP (Digital Signal Processor), alternatively or in addition to the CPU 901.

The CPU 901 serves as an operation processor and a controller, and controls all or some operations in the information processing apparatus 900 in accordance with various programs recorded in the ROM 903, the RAM 905, the storage unit 919 or a removable recording medium 927. The ROM 903 stores programs and operation parameters which are used by the CPU 901. The RAM 905 primarily stores program which are used in the execution of the CPU 901 and parameters which is appropriately modified in the execution. The CPU 901, ROM 903, and RAM 905 are connected to each other by the host bus 907 configured to include an internal bus such as a CPU bus. In addition, the host bus 907 is connected to the external bus 911 such as a PCI (Peripheral Component Interconnect/Interface) bus via the bridge 909.

The input unit 915 may be a device which is operated by a user, such as a mouse, a keyboard, a touch panel, buttons, switches and a lever. The input unit 915 may be, for example, a remote control unit using infrared light or other radio waves, or may be an external connection unit 929 such as a portable phone operable in response to the operation of the information processing apparatus 900. Furthermore, the input unit 915 includes an input control circuit which generates an input signal on the basis of the information which is input by a user and outputs the input signal to the CPU 901. By operating the input unit 915, a user can input various types of data to the information processing apparatus 900 or issue instructions for causing the information processing apparatus 900 to perform a processing operation.

The output unit 917 includes a device capable of visually or audibly notifying the user of acquired information. The output unit 917 may include a display unit such as LCD (Liquid Crystal Display), PDP (Plasma Display Panel), and organic EL (Electro-Luminescence) displays, an audio output unit such as speaker and headphone, and a peripheral device such as printer. The output unit 917 may output the results obtained from the process of the information processing apparatus 900 in a form of a video such as text or image, and an audio such as voice or sound.

The storage unit 919 is a device for data storage which is configured as an example of a storage unit of the information processing apparatus 900. The storage unit 919 includes, for example, a magnetic storage device such as HDD (Hard Disk Drive), a semiconductor storage device, an optical storage device, or a magneto-optical storage device. The storage unit 919 stores programs to be executed by the CPU 901, various data, and data obtained from the outside.

The drive 921 is a reader/writer for the removable recording medium 927 such as a magnetic disk, an optical disk, a magneto-optical disk, or a semiconductor memory, and is embedded in the information processing apparatus 900 or attached externally thereto. The drive 921 reads information recorded in the removable recording medium 927 attached thereto, and outputs the read information to the RAM 905. Further, the drive 921 can write in the removable recording medium 927 attached thereto.

The connection port 923 is a port used to directly connect devices to the information processing apparatus 900. The connection port 923 may include a USB (Universal Serial Bus) port, an IEEE1394 port, and a SCSI (Small Computer System Interface) port. The connection port 923 may further include an RS-232C port, an optical audio terminal, an HDMI (High-Definition Multimedia Interface) port, and so on. The connection of the external connection unit 929 to the connection port 923 makes it possible to exchange various data between the information processing apparatus 900 and the external connection unit 929.

The communication unit 925 is, for example, a communication interface including a communication device or the like for connection to a communication network 931. The communication unit 925 may be, for example, a communication card for a wired or wireless LAN (Local Area Network), Bluetooth (registered trademark), WUSB (Wireless USB) or the like. In addition, the communication unit 925 may be a router for optical communication, a router for ADSL (Asymmetric Digital Subscriber Line), a modem for various kinds of communications, or the like. The communication unit 925 can transmit and receive signals to and from, for example, the Internet or other communication devices based on a predetermined protocol such as TCP/IP. In addition, the communication network 931 connected to the communication unit 925 may be a network or the like connected in a wired or wireless manner, and may be, for example, the Internet, a home LAN, infrared communication, radio wave communication, satellite communication, or the like.

The imaging unit 933 is a device that generates an image by imaging a real space using an image sensor such as a charge-coupled device (CCD) or complementary metal-oxide-semiconductor (CMOS) sensor, as well as various members such as one or more lenses for controlling the formation of a subject image on the image sensor, for example. The imaging unit 933 may be a device that takes still images, and may also be a device that takes moving images.

The sensor 935 is any of various sensors such as an acceleration sensor, a gyro sensor, a geomagnetic sensor, an optical sensor, or a sound sensor, for example. The sensor 935 acquires information regarding the state of the information processing apparatus 900, such as the orientation of the case of the information processing apparatus 900, as well as information regarding the environment surrounding the information processing apparatus 900, such as the brightness or noise surrounding the information processing apparatus 900, for example. The sensor 935 may also include a Global Positioning System (GPS) sensor that receives GPS signals and measures the latitude, longitude, and altitude of the apparatus.

The foregoing thus illustrates an exemplary hardware configuration of the information processing apparatus 900. Each of the above components may be realized using general-purpose members, but may also be realized in hardware specialized in the function of each component. Such a configuration may also be modified as appropriate according to the technological level at the time of the implementation.

### (7. Supplemental Remarks)

Embodiments of the present disclosure encompass an information processing apparatus (such as a terminal device or an electronic pen), a writing instrument (not limited to an electronic pen) and system as described in the foregoing, an information processing method executed by an information processing apparatus or system, a program for causing an information processing apparatus to function, and a recording medium storing such a program, for example.

It should be understood by those skilled in the art that various modifications, combinations, sub-combinations and alterations may occur depending on design requirements and other factors insofar as they are within the scope of the appended claims or the equivalents thereof.

Additionally, the present technology may also be configured as below.

(1) An information processing apparatus including:

a sensor information acquisition unit that acquires sensor information output from a sensor that detects contact of a finger with a surface of a writing instrument;

a grip pattern determination unit that determines, based on the sensor information, a grip pattern in which a user grips the writing instrument; and

a function execution unit that executes a function relating to the writing instrument according to the grip pattern.

(2) The information processing apparatus according to (1), wherein the function execution unit executes the function when the grip pattern coincides with an exemplary pattern.
(3) The information processing apparatus according to (2), further including:

a coordinate information acquisition unit that acquires coordinate information indicating a position of the writing instrument that is an electronic pen on a surface to be written upon,

wherein the function is outputting writing data according to the coordinate information.

(4) The information processing apparatus according to (1), wherein the function execution unit executes the function when the grip pattern does not coincide with an exemplary pattern.
(5) The information processing apparatus according to (4), wherein the function is outputting feedback information indicating that the grip pattern is different from the exemplary pattern.
(6) The information processing apparatus according to (5), wherein the function execution unit causes the feedback information to be displayed on a display unit of a device to be used by the user.
(7) The information processing apparatus according to (5) or (6), wherein the function execution unit causes the feedback information to be displayed on a display unit of a device to be used by a supervisor of the user who is a learner.
(8) The information processing apparatus according to any one of (5) to (7), wherein the function execution unit provides the writing instrument with the feedback information.
(9) The information processing apparatus according to (11), wherein the function execution unit switches functions to be executed according to the grip pattern.
(10) The information processing apparatus according to (9), further including:

a coordinate information acquisition unit that acquires coordinate information indicating a position of the writing instrument that is an electronic pen on a surface to be written upon,

wherein the function execution unit executes output of writing data according to the coordinate information in a case where the grip pattern coincides with an exemplary pattern, and executes another function in another case.

(11) The information processing apparatus according to any one of (1) to (10), wherein the sensor information includes information indicating contact or non-contact of a finger with a sensing point disposed on the surface of the writing instrument.
(12) The information processing apparatus according to any one of (1) to (10), wherein the sensor information includes information indicating a shape of a contact area of a finger with a sensing area disposed on the surface of the writing instrument.
(13) The information processing apparatus according to any one of (1) to (12), wherein the sensor information includes information indicating contact pressure of a finger on the surface of the writing instrument.
(14) The information processing apparatus according to any one of (1) to (13), wherein the information processing apparatus is built in the writing instrument.
(15) The information processing apparatus according to any one of (1) to (13), further including:

a communication unit that communicates with the writing instrument.

(16) A writing instrument including:

a first sensor that detects contact of a finger with a surface of the writing instrument; and

a sensor information providing unit that provides sensor information output from the first sensor to a device that determines, based on the sensor information, a grip pattern in which a user grips the writing instrument.

(17) The writing instrument according to (16), further including:

a second sensor that detects contact of the writing instrument with a surface to be written upon; and

a control unit that executes activation control of one or both of the first sensor and the sensor information providing unit according to a detection result of the second sensor.

(18) The writing instrument according to (16) or (17), further including:

a third sensor that detects that the writing instrument is taken out from a case; and

a control unit that executes activation control of one or both of the first sensor and the sensor information providing unit according to a detection result of the third sensor.

(19) An information processing method including:

acquiring sensor information output from a sensor that detects contact of a finger with a surface of a writing instrument;

determining, based on the sensor information, a grip pattern in which a user grips the writing instrument; and

executing a function relating to the writing instrument according to the grip pattern.

(20) A program causing a computer to realize:

a function of acquiring sensor information output from a sensor that detects contact of a finger with a surface of a writing instrument;

a function of determining, based on the sensor information, a grip pattern in which a user grips the writing instrument; and

a function of executing a function relating to the writing instrument according to the grip pattern.

The present disclosure contains subject matter related to that disclosed in Japanese Priority Patent Application JP 2012-206787 filed in the Japan Patent Office on Sep. 20, 2012, the entire content of which is hereby incorporated by reference.

What is claimed is:

1. An information processing apparatus comprising:
a sensor information acquisition unit that acquires sensor information output from a sensor that detects contact of a finger with a surface of a writing instrument;
a grip pattern determination unit that determines, based on the sensor information, a grip pattern in which a user grips the writing instrument; and
a function execution unit that executes a function relating to the writing instrument according to the grip pattern.

2. The information processing apparatus according to claim 1, wherein the function execution unit executes the function when the grip pattern coincides with an exemplary pattern.

3. The information processing apparatus according to claim 2, further comprising:
a coordinate information acquisition unit that acquires coordinate information indicating a position of the writing instrument that is an electronic pen on a surface to be written upon,
wherein the function is outputting writing data according to the coordinate information.

4. The information processing apparatus according to claim 1, wherein the function execution unit executes the function when the grip pattern does not coincide with an exemplary pattern.

5. The information processing apparatus according to claim 4, wherein the function is outputting feedback information indicating that the grip pattern is different from the exemplary pattern.

6. The information processing apparatus according to claim 5, wherein the function execution unit causes the feedback information to be displayed on a display unit of a device to be used by the user.

7. The information processing apparatus according to claim 5, wherein the function execution unit causes the feedback information to be displayed on a display unit of a device to be used by a supervisor of the user who is a learner.

8. The information processing apparatus according to claim 5, wherein the function execution unit provides the writing instrument with the feedback information.

9. The information processing apparatus according to claim 1, wherein the function execution unit switches functions to be executed according to the grip pattern.

10. The information processing apparatus according to claim 9, further comprising:
a coordinate information acquisition unit that acquires coordinate information indicating a position of the writing instrument that is an electronic pen on a surface to be written upon,
wherein the function execution unit executes output of writing data according to the coordinate information in a case where the grip pattern coincides with an exemplary pattern, and executes another function in another case.

11. The information processing apparatus according to claim 1, wherein the sensor information includes information indicating contact or non-contact of a finger with a sensing point disposed on the surface of the writing instrument.

12. The information processing apparatus according to claim 1, wherein the sensor information includes information indicating a shape of a contact area of a finger with a sensing area disposed on the surface of the writing instrument.

13. The information processing apparatus according to claim 1, wherein the sensor information includes information indicating contact pressure of a finger on the surface of the writing instrument.

14. The information processing apparatus according to claim 1, wherein the information processing apparatus is built in the writing instrument.

15. The information processing apparatus according to claim 1, further comprising:
a communication unit that communicates with the writing instrument.

16. A writing instrument comprising:
a first sensor that detects contact of a finger with a surface of the writing instrument; and
a sensor information providing unit that provides sensor information output from the first sensor to a device that determines, based on the sensor information, a grip pattern in which a user grips the writing instrument.

17. The writing instrument according to claim 16, further comprising:
a second sensor that detects contact of the writing instrument with a surface to be written upon; and
a control unit that executes activation control of one or both of the first sensor and the sensor information providing unit according to a detection result of the second sensor.

18. The writing instrument according to claim 16, further comprising:
a third sensor that detects that the writing instrument is taken out from a case; and
a control unit that executes activation control of one or both of the first sensor and the sensor information providing unit according to a detection result of the third sensor.

19. An information processing method comprising:
acquiring sensor information output from a sensor that detects contact of a finger with a surface of a writing instrument;
determining, based on the sensor information, a grip pattern in which a user grips the writing instrument; and
executing a function relating to the writing instrument according to the grip pattern.

20. A program causing a computer to realize:
a function of acquiring sensor information output from a sensor that detects contact of a finger with a surface of a writing instrument;
a function of determining, based on the sensor information, a grip pattern in which a user grips the writing instrument; and
a function of executing a function relating to the writing instrument according to the grip pattern.
